(19) United States
(12) Patent Application Publication
(10) Pub. No.: US 2007/0092123 A1
(43) Pub. Date: Apr. 26, 2007

(54) Method and device for movement correction when imaging the heart

(76) Inventor: Stefan Popescu, Erlangen (DE)

Correspondence Address: HARNESS, DICKEY & PIERCE, P.L.C., P.O.BOX 8910, RESTON, VA, 20195, US

(21) Appl. No.: 11/581,361

(22) Filed: Oct. 17, 2006

(30) Foreign Application Priority Data
Oct. 18, 2005 (DE) 10 2005 049 862.0

(51) Int. Cl. G06K 9/00

(52) U.S. Cl. 382/128

(57) ABSTRACT

A method and a device are disclosed for movement correction when imaging the heart. In an embodiment of the method, a number of pictures of at least one region of the heart, that are subsequently combined with one another to generate a combined image data record, are recorded with the aid of an imaging unit in a space of time comprising a number of heart periods. In an embodiment of the method, an additional measuring device is used to acquire, during the recordings, measured data from which it is possible to calculate a variation in a spatial position of the heart between heart periods. The measured data are used to calculate the variation in the spatial position of the heart between the heart periods, in order to reduce errors in the image data record that are caused by the variation. The method, in an embodiment, renders possible combined image data records of the heart with reduced image artifacts.

### PRIORITY STATEMENT

The present application hereby claims priority under 35 U.S.C. §119 on German patent application number DE 10 2005 049 862.0 filed Oct. 18, 2005, the entire contents of which is hereby incorporated herein by reference.

1. Field

The present invention generally relates to a method and/or a device for movement correction when imaging the heart. For example, it may relate to one in the case of which a number of pictures of at least one region of the heart that are subsequently combined with one another to generate a combined image data record are recorded with the aid of an imaging unit in a space of time comprising a number of heart periods.

2. Background

Different imaging techniques such as, for example, computer aided tomography (CT), magnetic resonance tomography (MR), positron emission tomography (PET), single photon emission computed tomography (SPECT) or an ultrasound technique (US) can be used for imaging the heart. Precisely in the case of applications for which the aim is to record a three-dimensional image data record of the heart or of a subvolume of the heart, imaging leads without further measures to movement artifacts because of the low recording speed of volume data by comparison with a relatively short phase within the heart period in which the heart is virtually at a standstill. In order to avoid these movement artifacts, the imaging is therefore synchronized with the heartbeat or the heart period, for example in order to generate three-dimensional image data records of cardiac vessels or other anatomical details of the heart.

The entire imaging extends in this case over a number of heart periods, image data respectively being recorded or evaluated only in the same heart phase of each heart period. The synchronization is performed as a rule via an ECG control (ECG: electrocardiogram), also denoted as ECG gating. A trigger signal is thereby derived from the measurement of the electrical activity of the cardiac muscle.

It is also possible in addition to apply respiratory control, the so-called respiratory gating, in order also to obtain a synchronization with the respiratory movement. Despite this and other known synchronization techniques, movement artifacts occur as before in the 3D image data records obtained in this way, and lead to a reduction in the spatial resolution of the images.

EP 1 055 935 A2 describes a method for magnetic resonance imaging of the heart, in the case of which a respiratory gating technique is applied. In order to derive the synchronization signal for the respiratory gating, the position of the diaphragm is detected in this case between the individual MR pictures with the aid of a navigator pulse sequence in order thereby to monitor the respiratory movement. The image data are subsequently correctly assembled taking account of the measured position of the diaphragm in the respective picture. This requires prescanning that assigns a position of a reference point in the heart to the respective respiratory phase detected by the position of the diaphragm.

EP 1 593 984 A1 discloses a method for magnetic resonance imaging in the case of which ECG gating and respiratory gating are used in order to avoid movement artifacts in the recorded images. In the case of this method, as well, it is possible to use a navigator pulse sequence to detect the position of the diaphragm in order therefrom to derive a respiratory gating signal and information for image correction.

US 2005/0113672 A1 describes a method and a device for using different information for gating signals in order to avoid movement artifacts when recording images. In this method, a number of items of movement information relating to an organ such as the heart are acquired simultaneously in order to derive a gating signal therefrom. The instant of the least movement of the organ is determined from the movement information and used for the gating.

It is also possible to use the movement information to determine movement correction factors with the aid of which the recorded images of the organ are then corrected. However, this requires iterative methods in the case of a direct use of the acquired movement information. Various techniques such as, for example, also electrical acquisition techniques such as ECG or VCG are specified for acquiring the movement information.

DE 695 29 667 T2 describes a method and unit for imaging with the aid of magnetic resonance. In order, in this case, to reduce movement artifacts, the position of the moving part is detected with the aid of navigator pulse sequences in order thereafter to correct the image data appropriately. However, the movement is detected only in one direction with the aid of such a navigator technique.

The printed publication also indicates how to utilize the positions of the heart determined with the aid of navigator signals to undertake other movement corrections such as, for example, a continuous rotation matrix adaptation. However, it remains in this context an open question how to detect a rotation of the heart during the respiratory movement or to derive it from the positions detected by the navigator signals.

### SUMMARY

In at least one embodiment of the present invention, a method and/or a device is specified for movement correction when imaging the heart with the aid of which these movement artifacts can be further reduced.

In the case of at least one embodiment of the present method for movement correction when imaging the heart, a number of pictures of at least one region of the heart that are subsequently combined with one another to generate a combined image data record are recorded with the aid of an imaging unit in a space of time comprising a number of heart periods. A heart period is understood here to be the period of the heartbeat. The imaging techniques of computed tomography, magnetic resonance tomography, positron emission tomography, single photon emission computed tomography or ultrasonic imaging can, for example, be applied for recording images. The generation of the combined image data record comprises, for example, the production of a 3D image data record from individual tomograms recorded at different positions of the heart. In addition to the production of a 3D image data record, the method can, however, also be used for other applications in which pictures recorded in different heart periods are combined with one another, for example subtracted from one another.

The present method, in at least one embodiment, is distinguished chiefly in that during the recordings an additional measuring device is used to acquire measured data for producing vector cardiograms (VCG) of the heart from which a variation in the spatial position of the heart between heart periods following one another in each case, or in relation to a prescribable heart period, is calculated. The calculated variation is taken into account when combining the pictures, in order to avoid or at least to reduce errors in the combined image data record that are caused by the variation in the spatial position of the heart. The spatial position of the heart is understood here as the spatial position and orientation of the heart.

In the case of at least one embodiment of the present method, the imaging is carried out with the aid of a gating technique in order to ensure that each recording is performed in the same heart phase, or that use is made for the purpose of producing a combined image data record only of pictures that have been recorded in the same heart phase (retrospective gating). The movement artifacts in the combined image data record are again reduced by taking account of the variation in the spatial position of the heart between heart periods or heartbeats following one another. Use is made in this case of the realization that the heart movement comprises not only the contractions of the cardiac muscle, but also that the heart can change the spatial position between the individual heart periods, that is to say can be displaced and/or rotated.

The spatial position of the heart can vary from heartbeat to heartbeat owing to this displacement and/or rotation. This nonperiodic variation cannot be compensated by known gating or synchronization techniques. However, it is also possible for image artifacts originating from this cause to be reduced or avoided by the detection of this variation in the spatial position of the heart during recording of the pictures and the consideration of these variations during the generation of the combined image data record from the individual pictures. This is the particular advantage of at least one embodiment of the present invention with the aid of which combined image data records, in particular 3D image data records, can be obtained with increased spatial resolution.

Of course, the movement correction carried out in the case of at least one embodiment of the present method on the basis of the calculated variation in the spatial region of the heart can also be further refined with the aid of additional techniques such as, for example, comparing the images of pictures following one another.

Orthogonal vector cardiography is carried out in the case of the present method in order to obtain vector cardiograms (VCGs) of the electrical activity of the cardiac muscle from which it is possible to detect and calculate the variations in the spatial position of the heart from heart period to heart period or from heartbeat to heartbeat, or else in relation to a heart period fixed as reference. The measured data are respectively recorded in this case simultaneously with the recording of the images, the later production of the combined image data record requiring information to be stored as to which recorded image and which measured data are assigned to which heart period.

During vector cardiography, which is a variant of electrocardiography, the electrical activities of the heart are recorded in order to determine therefrom the time profile of the value and the direction of the electric heart vector during a heart period. The electric heart vector constitutes an electric dipole that can be used to represent the heart on the basis of its electric activity. A vector cardiogram represents the time profile of the value and of the direction of the electric heart vector during a heart period, and corresponds to a three-dimensional curve that is closed in on itself as a rule, also denoted below as a VCG loop that is, in turn, composed of a number of subloops.

A change in the spatial position of the heart is also accompanied by a change in the spatial position of the electric dipole, and thus by a change in the spatial position of the VCG loop in the vector cardiogram. This change in the spatial position of the VCG loop in the vector cardiogram between two heart periods is detected in the case of at least one embodiment of the present method and quantified in order therefrom to calculate the variation in the spatial position of the heart between two heart periods.

In a development of at least one embodiment of the method, abnormal QRS complexes that are based on arrhythmic heartbeats are detected in the vector cardiograms: premature beats, premature ventricular contractions or ectopic heartbeats. Extrasystolic QRS loops can easily be detected in vector cardiograms, since they differ significantly in shape and orientation from normal (systolic) QRS loops. Arrhythmic heartbeats lead to modified ECG/VCG signals that prevent movement from being properly corrected. In the case of the present development of at least one embodiment of the method, the picture recorded in such a heart period is therefore not subjected to any movement correction. The entire picture is preferably rejected (so that it does not contribute to the combined image data record) and recorded anew in one of the following heart periods.

The so-called VCG normalization is carried out in a further advantageous development of at least one embodiment of the method by using vector cardiograms. What is involved here is a technique where an attempt is made to convert the VCG loops of two heart periods into one another by a 3D transformation. Heart periods following one another can, for example, be involved in this case. However, it is also possible to define or select a reference VCG loop, and to normalize the VCG loops of all the other heart periods thereto. The characteristic parameters of this 3D transformation (Eigen values, angles of rotation) can be used as indicators of changes in the state of the heart. If the VCG loops of the heart periods considered can in each case be converted into one another by a linear transformation (rotation and displacement), the spatial position of the heart has varied only in the usual way. The movement correction can be carried out in this case. If the transformation is not linear, this indicates an abnormal heartbeat, and the movement correction is either not carried out for the associated picture, or the picture is rejected.

When carrying out at least one embodiment of the present method by recording vector cardiograms, the trigger signal synchronizing the recording of the pictures with the heart phase is preferably also derived from the vector cardiograms. This leads to a very reliable, robust synchronization, since it is also possible, for example, to detect arrhythmic heart movements in the vector cardiograms such that no trigger signal is generated in this case.

In a further advantageous refinement of at least one embodiment, the vector cardiograms are also used to detect the time profile of respiration and to derive a trigger signal for a respiratory control. Since the respiratory movements act on the spatial position of the heart, it is also possible to determine this influence from the vector cardiograms. The variation in the spatial position of the heart that is associated with the respiratory movement is therefore automatically taken into account in the movement correction in the case of at least one embodiment of the present method.

Furthermore, the respiratory movement can also be determined by analyzing the vector cardiograms and be used to trigger the recordings of the images. It is possible in this case to dispense with the use of a separate respiration sensor. If appropriate, there is then no longer any need for the patient to have to hold his breath for a number of seconds during recording of the images.

The proposed device for carrying out at least one embodiment of the method includes one or more input interfaces for the pictures recorded with the imaging unit and for the measured data acquired with the additional measuring device, and an evaluation device having an analysis module and an image combination module. The analysis module is used to calculate the variation in the spatial position of the heart between the heart periods, and the image combination module is used to combine the recorded pictures by taking account of the calculated variation in the spatial position of the heart in order to produce a combined image data record in which errors caused by the variation in the position of the heart are at least reduced. The analysis module and the image processing module are designed in this case such that they can carry out the individual steps of the method according to at least one embodiment of the invention.

### BRIEF DESCRIPTION OF THE DRAWINGS

The present invention is explained briefly once more below with the aid of an example embodiment in association with the drawings, in which:

FIG. 1 shows an example of a cycle of the method in accordance with an embodiment of the present invention;

FIG. 2 shows an example of the temporal relation between an ECG/VCG signal and the contraction of the cardiac muscle; and

FIG. 3 shows an example of a vector cardiogram recorded during a heart period.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

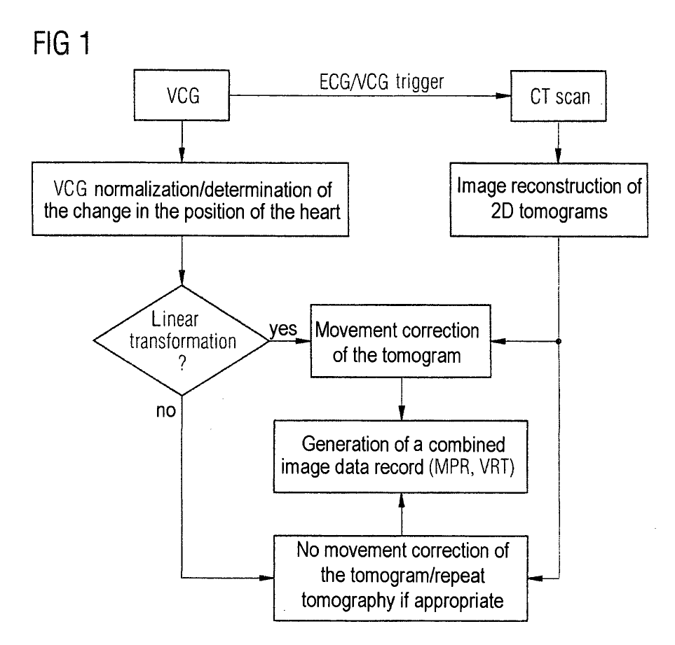

In the present example embodiment in accordance with FIG. 1, a three-dimensional image data record of the heart is generated with the aid of the technique of computed tomography. The CT scan is carried out in this case with the aid of a gating technique such that raw data are recorded synchronously with the heartbeat. Tomograms of the heart that are oriented perpendicular to the longitudinal axis (caudocranial, Z-axis) of the patient's body are recorded in this way in temporal sequence. These axial tomograms originate from different z-positions and different heart periods. The synchronization is preferably performed in such a way that an image is recorded in each case only in the motionless heart phase of each heart period.

An image reconstruction must firstly be carried out in advance from the raw data of the computer tomograph, by filtered back projection as a rule, in order to obtain the tomograms. The individual tomograms are subsequently combined with one another in accordance with their recording position, in order to obtain a combined image data record. The generation of the combined image data record can be performed, for example, by way of multiplanar reconstruction (MPR) or by way of a volume rendering technique (VRT). Reformatted axial images of different orientations are obtained in sagittal or frontal slices, for example, by MPR. 3D volume images can be generated by way of VRT.

In the case of an embodiment of the present invention, the production of the combined image data record (MPR, VRT) is performed by taking account of a variation, detected during the recording of the images, in the spatial position of the heart between two heart periods in each case. To this end, the individual tomograms are individually rotated, tilted or displaced for image correction in accordance with the calculated variation in the spatial position of the heart. An MPR or VRT image with reduced image artifacts is obtained in this way.

In the case of the present example embodiment, the variation in the spatial position of the heart between the different heart periods over which the images are recorded is detected by simultaneously recording vector cardiograms of the respective heart periods. The trigger signal for synchronizing the recording of images with the heartbeat is also derived from these vector cardiograms. The respective relative variation in the position of the heart between the different heart periods that is included in the movement correction is determined from the variation in the three-dimensional position of the VCG loops (compare FIG. 3) in the vector cardiograms.

A VCG normalization in which a 3D transformation is calculated between the VCG loops of neighboring heart periods is performed in the present example. If this transformation is linear and is therefore based on a displacement and/or rotation of the VCG loop, the variation in the position of the electric heart vector and thus of the heart can be determined directly therefrom. If such a linear transformation is determined, the image correction is carried out correspondingly. However, if no linear transformation is yielded, this indicates an arrhythmic heartbeat. No movement correction is carried out in this case. Furthermore, the associated recording of images can also be rejected such that it makes no contribution to the production of the combined image data record.

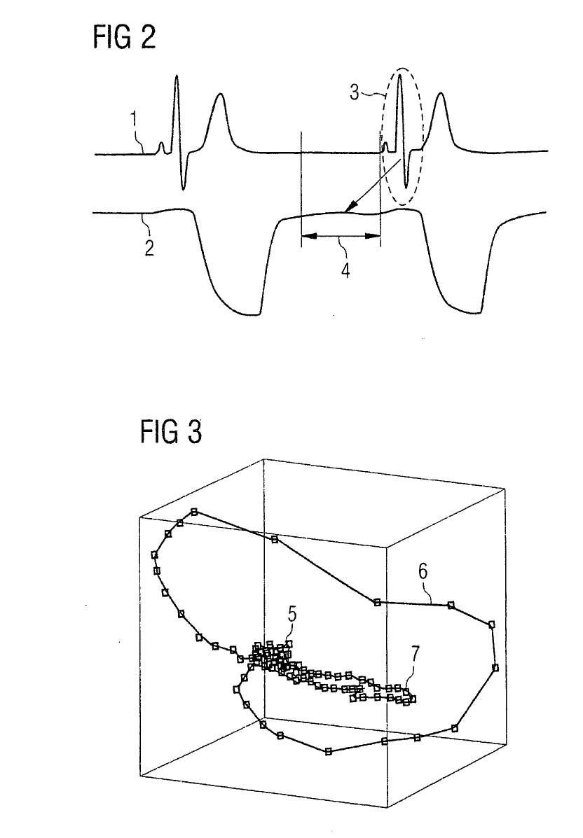

FIG. 2 shows an example of the temporal relationship between an electric ECG/VCG signal 1 and the mechanical contraction of the cardiac muscle, represented by the ventricle volume 2. The synchronized recording of images is preferably performed during the motionless phase 4 of the heart. Of course, it is also possible to record images during all the heart phases, but then of these, only images of the same heart phase are respectively used for the reconstruction. As may be seen from FIG. 2, an electric impulse, the so-called QRS complex 3, precedes the contraction of the cardiac muscle. This opens up the possibility of determining the variation in the spatial position of the heart as early as this point in time from the associated part of the vector cardiogram. In particular, it is already possible at this point in time to detect whether an arrhythmic heartbeat is present, since such a heartbeat can be detected by a modified QRS loop that is clearly detectable in the vector cardiogram. Consequently, a trigger signal derived from the vector cardiogram for the synchronization of the recording of the images can be omitted in this case.

FIG. 3 shows an example of a vector cardiogram in which the three-dimensional profile of the VCG loop in the X-Y-Z coordinate system of the computer tomograph can be discerned. This loop is composed of the P loop 4, the QRS loop 5 and the T loop 6. A change in the spatial position of the heart between two heart periods is also accompanied by a change in the spatial position of this VCG loop, and so the variation in the spatial position of the heart can be determined from this variation.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for movement correction when imaging the heart, comprising:
recording a number of pictures of at least one region of the heart with the aid of an imaging unit in a space of time including a number of heart periods;
using, during the recordings, a measuring device to acquire measured data for producing vector cardiograms of the heart;
calculating, from the vector cardiograms of the heart, a variation in a spatial position and orientation of the heart between heart periods; and
combining the recorded pictures with one another to generate a combined image data record, the calculated variation being taken into account when combining the recorded pictures to at least reduce errors in the combined image data record previously caused by variation in the spatial position and orientation of the heart.

2. The method as claimed in claim 1, wherein the recorded pictures are combined with one another to produce a 3D image data record of the acquired region of the heart.

3. The method as claimed in claim 1, wherein the pictures are subjected to a movement correction in accordance with the calculated variation in the spatial position and orientation of the heart.

4. The method as claimed in claim 1, wherein arrhythmic heart periods are detected with the aid of abnormal QRS complexes by analyzing the vector cardiograms, no movement correction being carried out for pictures recorded in an arrhythmic heart period.

5. The method as claimed in claim 4, wherein pictures recorded in an arrhythmic heart period are rejected and are repeated in a later heart period.

6. The method as claimed in claim 1, wherein the determination is made for the vector cardiograms of two heart periods, as to whether the associated vector cardiograms can be at least approximately converted into one another by a linear transformation, a movement correction of the picture recorded in the later of the two heart periods being carried out on the basis of the calculated variation in the spatial position and orientation of the heart only in the case of a linear transformation.

7. The method as claimed in claim 6, wherein the later picture is rejected if the vector cardiograms cannot be transformed at least approximately into one another by a linear transformation.

8. The method as claimed in claim 1, wherein the pictures are respectively recorded in the same phase of the heart period by using at least one of an electro-cardiogram controller and vector cardiogram controller.

9. The method as claimed in claim 1, wherein the pictures are recorded by respectively using a respiratory controller in the same phase of the respiratory movement, the respiratory movement and a trigger signal for the respiratory controller being derived from the vector cardiograms.

10. A device, comprising:
one or more input interfaces for pictures, recorded with an imaging unit, of at least one region of the heart and for measured data, acquired with the measuring device, to produce vector cardiograms of the hearts; and
an evaluation device, the evaluation device including,
an analysis module to produce vector cardiograms of the heart from the measured data and to calculate therefrom a variation in a spatial position and orientation of the heart between heart periods, and
an image combination module to produce a combined image data recording by combining the recorded pictures by taking account of the calculated variation in the spatial position and orientation of the heart between in each case two heart periods, in which image data record errors in the image data record previously caused by the variation are at least reduced.

11. The device as claimed in claim 10, wherein the image combination module is designed to combine the pictures with one another to produce a 3D image data record of the acquired region of the heart.

12. The device as claimed in claim 10, wherein the image combination module is designed, in accordance with the calculated variation in the spatial position and orientation of the heart, to subject the pictures to a movement correction.

13. The device as claimed in claim 10, wherein the analysis module is designed to detect arrhythmic heart periods with the aid of abnormal QRS complexes by analyzing the vector cardiograms, the image combination module being designed to carry out no movement correction for pictures that have been recorded in an arrhythmic heart period.

14. The device as claimed in claim 13, wherein the image combination module does not include, in the combined image data record, pictures recorded in an arrhythmic heart period.

15. The device as claimed in claim 10, wherein the analysis module is designed to determine, for the vector cardiograms of two heart periods, whether the vector cardiograms can be at least approximately converted into one another by a linear transformation, the image combination module being designed to carry out a movement correction of the picture recorded in the later of the two heart periods on the basis of the calculated variation in the spatial position and orientation of the heart only in the case of a linear transformation.

16. The device as claimed in claim 15, wherein the image combination module is designed such that it does not include the later picture in the combined image data record if the vector cardiograms cannot be transformed at least approximately into one another by a linear transformation.

17. The device as claimed in claim 10, wherein the analysis module is designed to derive a vector cardiogram trigger signal from the vector cardiograms and provide the signal such that the pictures can be respectively recorded in the same phase of the heart period by using a vector cardiogram controller.

18. The device as claimed in claim 10, wherein the analysis module is designed to derive a respiratory trigger signal from the vector cardiograms and provides the signal such that the pictures can be respectively recorded in the same phase of the respiratory movement by using a respiratory controller.

19. The method as claimed in claim 2, wherein the pictures are subjected to a movement correction in accordance with the calculated variation in the spatial position and orientation of the heart.

20. The method as claimed in claim 1, wherein the pictures are subjected to at least one of displacement, tilting and individual rotating in an appropriate fashion, in accordance with the calculated variation in the spatial position and orientation of the heart.

21. The method as claimed in claim 2, wherein the pictures are subjected to at least one of displacement, tilting and individual rotating in an appropriate fashion, in accordance with the calculated variation in the spatial position and orientation of the heart.

22. The device as claimed in claim 11, wherein the image combination module is designed, in accordance with the calculated variation in the spatial position and orientation of the heart, to subject the pictures to a movement correction.

23. The device as claimed in claim 10, wherein the image combination module is designed, in accordance with the calculated variation in the spatial position and orientation of the heart, to at least one of displace, tilt and rotate the pictures individually in an appropriate fashion.

24. The device as claimed in claim 11, wherein the image combination module is designed, in accordance with the calculated variation in the spatial position and orientation of the heart, to at least one of displace, tilt and rotate the pictures individually in an appropriate fashion.

25. A computer readable medium including program segments for, when executed on a computer device, causing the computer device to implement the method of claim 1.
